(19) United States
(12) Patent Application Publication
(10) Pub. No.: US 2026/0199877 A1
(43) Pub. Date: Jul. 16, 2026

(54) GOLD-CONTAINING CATALYST FOR REMOVAL OF HYDROGEN IN OXYGEN-RICH STREAMS

(71) Applicant: SHELL USA, INC., Houston, TX (US)

(72) Inventors: Peter John VAN DEN BRINK, Amsterdam (NL); Peter MUNNIK, Amsterdam (NL); Frank BOEHME, Leuna (DE); Wolfgang Dirk LOSE, Leuna (DE)

(21) Appl. No.: 19/134,754

(22) PCT Filed: Dec. 21, 2023
(86) PCT No.: PCT/US2023/085299

§ 371 Date: Jun. 2, 2025

(30) Foreign Application Priority Data
Dec. 23, 2022 (EP) 22216312.3

(51) Int. Cl. B01J 23/52; B01J 21/04; B01J 35/30; B01J 35/51; B01J 35/61; B01J 35/63; B01J 37/02; B01J 37/06; B01J 37/18; C25B 1/04

(52) U.S. Cl. CPC B01J 23/52; B01J 21/04; B01J 35/394; B01J 35/51; B01J 35/615; B01J 35/635; B01J 37/0213; B01J 37/0236; B01J 37/06; B01J 37/18; C25B 1/04

(57) ABSTRACT

A process for removing hydrogen from an oxygen gas stream includes electrolysing water in an electrolyser to generate a hydrogen-rich stream and an oxygen-rich stream. The oxygen-rich stream includes hydrogen. The process also includes feeding the oxygen-rich stream to a reactor having a gold-containing catalyst and contacting, in the reactor, the oxygen-rich stream with the gold-containing catalyst. The gold-containing catalyst includes gold and a second metal on an oxidic support and an oxygen partial pressure of the oxygen-rich stream in the reactor is greater than 1 bar.

The present disclosure relates to removal of hydrogen from oxygen-rich streams. More specifically, the present disclosure relates to a gold-containing catalyst composition and a method of making the gold-containing catalyst composition used for the removal of hydrogen in oxygen-rich streams.

### BACKGROUND

There is a demand for alternative non-fossil-based energy as the shift from fossil-based energy carriers to low carbon energy solutions continue to progress. One such low carbon energy carrier is hydrogen. Hydrogen may be produced through thermochemical conversion (e.g., from biogas or natural gas) or electrolysis, which splits water into hydrogen and oxygen. Hydrogen produced via electrolysis, using green power as the energy source, is of particular interest as this hydrogen (also known as green hydrogen) has the lowest greenhouse gas emissions compared to other techniques used to produce hydrogen. The electrolysis of water to form hydrogen and oxygen occurs in an electrolyser having an anode and a cathode separated by an electrolyte. At the anode, water reacts to form oxygen (O₂) and hydrogen ions (H⁺). The H⁺ ions move across the electrolyte to the cathode side of the electrolyser to form hydrogen gas (H₂). The electrolyser outputs an H₂ gas stream that is further processed to remove contaminating amounts of oxygen and water before use.

In addition to the H₂ gas stream, the electrolyser also outputs an O₂-rich stream. The O₂-rich stream may also be used for various purposes. To enable safe storage, safe transport, and optimal use this O₂-rich stream needs to be further processed to remove contaminating amounts of water and H₂ gas. Moreover, H₂ is considered to act as a greenhouse gas. Therefore, removal of H₂ from certain gas streams, such as the O₂-rich stream, may be required by governing agencies before use and/or releasing into the environment. One technique for removing H₂ gas from the O₂-rich stream is catalytic oxidation, where the hydrogen is reacted with a surplus of oxygen in a catalytic convertor to generate water. This water is then removed downstream in a separate unit. For example, in deoxygenation of the H₂ gas stream, palladium (Pd) and platinum (Pt) based catalysts are used. In Hanson et. al, the reaction between H₂ and O₂ over supported platinum catalysts was evaluated. (Hanson et. al, The Reaction between H₂ and O₂ over Supported Platinum Catalysts, Journal of Catalysis, 53, pages 56-67.) However, these catalysts are unsuitable for H₂ removal from oxygen-rich streams. It was found that in oxygen-rich environments, at elevated pressure and temperatures below 100 degrees Celsius (° C.), these catalysts exhibited a much lower activity than was to be expected when compared to the same reaction in oxygen-lean environments. Accordingly, it may be advantageous to develop a catalyst having a desirable activity and stability for use in the removal of H₂ from O₂-rich streams at low temperature.

### BRIEF SUMMARY

In one embodiment, a process for removing hydrogen from an oxygen gas stream includes electrolysing water in an electrolyser to generate a hydrogen-rich stream and an oxygen-rich stream. The oxygen-rich stream includes hydrogen. The process also includes feeding the oxygen-rich stream to a reactor having a gold-containing catalyst and contacting, in the reactor, the oxygen-rich stream with the gold-containing catalyst. The gold-containing catalyst includes gold and a second metal on an oxidic support, and an oxygen partial pressure of the oxygen-rich stream in the reactor is greater than 1 bar.

Additional features and advantages of exemplary implementations of the disclosure will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

Advantages of the disclosure may become apparent upon reading the following detailed description and upon reference to the drawings in which:

FIG. 1 is a block diagram of a system having an electrolyser and hydrogen removal reactor, whereby the hydrogen removal reactor includes a catalyst that removes hydrogen (H₂) from an oxygen (O₂)-rich stream generated in the electrolyser, in accordance with an embodiment of the present disclosure; and

FIG. 2 is a flow diagram of a method of making a bi-metallic catalyst for use in removal of H₂ from the O₂-rich stream generated in the system of FIG. 1, in accordance with an embodiment of the present disclosure.

### DETAILED DESCRIPTION

One or more specific embodiments of the present disclosure will be described below. These described embodiments are examples of the presently disclosed techniques. Additionally, in an effort to provide a concise description of these embodiments, not all features of an actual implementation may be described in the specification. It should be appreciated that in the development of any such actual implementation, as in any engineering or design project, numerous implementation-specific decisions will be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The terms “approximately,” “about,” and “substantially” as used herein represent an amount close to the stated amount that still performs a desired function or achieves a desired result. For example, the terms “approximately,” “about,” and “substantially” may refer to an amount that is within less than 10% of, within less than 5% of, within less than 1% of, within less than 0.1% of, and within less than 0.01% of a stated amount.

The energy transition has created opportunities for alternative fuel and energy solutions that significantly decrease or eliminate carbon dioxide (CO₂) emissions compared to traditional fossil-based fuels. An attractive alternative energy solution is hydrogen due, in part, to its high energy density and zero CO₂ emission. There are various types of hydrogen (e.g., grey, blue, green, etc.) depending on its source. For example, hydrogen produced via thermochemical conversion of natural gas is known as grey hydrogen. Blue hydrogen is also produced through thermochemical conversion of natural gas. However, the difference between grey hydrogen and blue hydrogen is that, in blue hydrogen, CO₂ is captured and stored underground. Green hydrogen is generated from a renewable source and has the lowest CO₂ emissions compared to grey and blue hydrogen.

Green hydrogen may be generated through splitting of water (H₂O) via electrolysis. In electrolysis, water is electronically split into hydrogen (H₂) gas and oxygen (O₂) gas to generate an H₂-rich output steam and an O₂-rich output stream. The H₂-rich output stream has contaminating amounts of O₂ and water. Similarly, the O₂-rich output stream has contaminating amounts of H₂ and water. These contaminants are removed from the output streams prior to use. Several noble metal-based catalysts exist for removal of O₂ and H₂ from various streams. For example, palladium (Pd) and/or platinum (Pt)-based catalysts are used to catalyze reactions for the removal of O₂ and H₂. Generally, these catalysts are used for the removal of O₂ from H₂-rich output streams, selective removal of H₂ from hydrocarbon streams or from carbon monoxide (CO) streams, and removal of H₂ buildup in batteries. For these applications, typical reaction conditions in these catalytic processes may be at inlet temperatures below approximately 100 degrees Celsius (° C.). Moreover, these applications are typically executed at a relatively low oxygen partial pressure (e.g., O₂ partial pressures of less than approximately 0.2 bar, as is the partial pressure of oxygen in air). However, the O₂ partial pressure in the O₂-rich output stream generated from the electrolysis of water is generally in the range of between approximately 1 bar and approximately 5 bar or higher. It has been found that noble metal-based catalysts generally applied in the catalytic reaction between hydrogen and oxygen, such as Pd, Pt, or Pd/Pt-based catalysts, have undesirable performance when temperatures are below 160°, in particular, when below 100° C. and the O₂ partial pressure is above 1 bar (e.g., 5 bar). That is, these noble metal-based catalysts have poor activity and stability and become oxidized in the O₂-rich environment.

For example, the effects of oxygen partial pressure on the catalytic performance of a Pd catalyst having 0.5 wt. % Pd, are illustrated in Table 1. This catalyst represents a state of the art noble metal-based catalyst, herewith to be regarded as a comperative sample and its preparation is provided in EX. 3 below. In EXP. 1, the Pd catalyst was contacted with a gas stream mimicking that of an electrolyser O₂ off gas having a H₂ concentration of 1000 parts per million volume (ppmv) (i.e., 5 millibar (mbar)) at an O₂ partial pressure of 5 bar, an hourly gas space velocity of 10000 hr⁻¹ and a temperature of 115° C. For comparison, in EXP. 2, the Pd catalyst was contacted with a gas stream having the same 1000 ppmv H₂ concentration and in which a major part of the O₂ was replaced with nitrogen (N₂) gas to lower the O₂ partial pressure from 5 bar to 0.25 bar. The concentration of H₂ was measured in the outlet gas and shown in Table 1 below.

TABLE 1
Hydrogen removal Activity of Pd Catalyst
in Oxygen-Containing Gas Streams

| | EXP. 1 | EXP. 2 |
|---|---|---|
| O₂ Partial Pressure (bar) | 5 | 0.25 |
| Concentration of H₂ at outlet (ppmv) | 600 | 40 |
| % Conversion | 40 | 96 |

As shown in Table 1, the performance of the Pd catalyst is undesirable when the partial pressure of O₂ is high (e.g., 5 bar) based on the 40% conversion of H₂ compared to when the O₂ partial pressure is low (e.g., 0.25 bar). Without being bound by theory, it is believed that the decrease in catalytic performance of the Pd catalyst in the presence of an O₂-rich gas is due, in part, to the oxidating environment created by the O₂ gas at the high (e.g., 5 bar) O₂ partial pressure. Due to this high oxygen partial pressure the reactive sites at the Pd nanoparticles that are present in the catalyst become oxidized, thus obstructing the reaction with hydrogen. To achieve the necessary activity for high conversions at the gas hourly space velocity the catalyst needs, the oxidized Pd catalyst needs to be re-activated by reduction in an oxygen free environment at regular intervals, which could range from a few hours to a few months depending on the standard conditions and the way the reactor is operated. Such operation is undesirable.

Another technique for improving catalyst performance to achieve high conversions for a given gas hourly space velocity is to increase the reaction temperature. However, in O₂-rich environments and O₂ partial pressures above1 bar, increasing the reaction temperature is suboptimal and complex as this may introduce safety concerns and impact equipment metallurgy due to reactions with equipment surfaces that are in contact with the O₂-rich gas.

In addition, the presence of water vapor in electrolyser O₂-rich off gas adds additional complexity and also affects catalyst performance. For example, electrolyser O₂-rich off gas may have dew points close to a temperature of the electrolyser used for the electrolysis of water, which is approximately 57° C. and corresponds to approximately 0.17 bar. Additionally, unlike the electrolyser H₂-rich off gas that promotes self-activation of noble metal catalyst by self-reduction, the electrolyser O₂-rich off gas promote oxidation, as discussed above. Therefore, when noble metal catalysts are used for treatment of O₂-rich streams, they become oxidized and catalyst performance and stability decrease compared to reduced noble metal catalyst. However, as discussed in further detail below, it has been surprisingly found that by incorporating gold (Au) into the catalyst, the catalytic performance and stability of noble metal catalyst is improved when used in removal of hydrogen of O₂-rich streams.

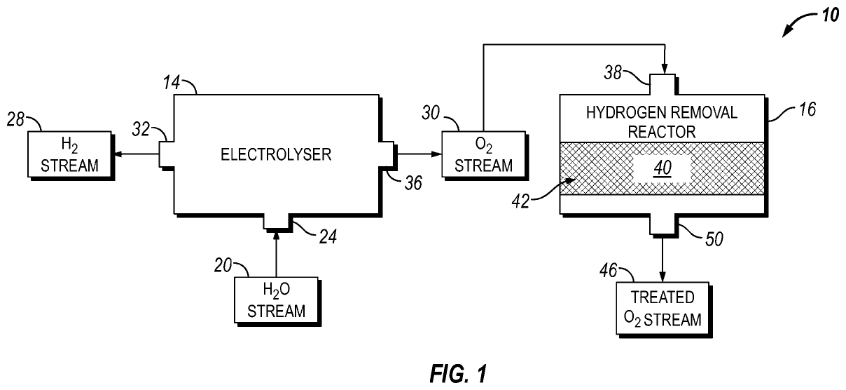

With the foregoing in mind, FIG. 1 is a block diagram of a system 10 that may be used in a process for generating an oxygen-rich stream having contaminating levels of H₂ and removing the H₂ from an oxygen-rich stream. As discussed in detail below, the system 10 uses the catalyst of the present disclosure for removing H₂ from an oxygen-rich stream and includes an electrolyser 14 and a hydrogen removal reactor 16. In the illustrated embodiment, the electrolyser 14 receives a water (H₂O) stream 20 through an inlet 24 and, via electrochemistry, splits the water in the H₂O stream 20 into a hydrogen (H₂)-rich stream 28 and an oxygen (O₂)-rich stream 30. The electrolyser 14 includes a first outlet 32 for outputting the H₂-rich stream 28 and a second outlet 36 for outputting the O₂-rich stream 30. Splitting of water via electrolysis is a well-known process in the art and will not be described in detail. As discussed above, O₂-rich streams generated from the electrolysis of water, such as the O₂-rich stream 30, have contaminating amounts of H₂. Therefore, prior to use, the contaminating amount of H₂ in the O₂-rich stream 30 is removed. Accordingly, as shown in the illustrated embodiment, the O₂-rich stream 30 is fed to the reactor 16 through a reactor inlet 38. The reactor 16 contains one or more catalyst beds 40 having a gold-containing hydrogen removal catalyst 42. In the reactor 16, the O₂-rich stream 30 contacts the catalyst 42 and the contaminating amount of H₂ is removed, thereby generating a treated O₂-rich stream 46 that is essentially free of H₂ (e.g., contains less than approximately 50 ppmv H₂, preferably less than 10 ppmV). Accordingly, the treated O₂-rich stream 46 may have between approximately 95 to 100% less hydrogen compared to the O₂-rich stream 30. The treated O₂-rich stream 46 may be released from the reactor 16 though a reactor outlet 50 and further processed in subsequent downstream processes. Depending on the use of the treated O₂-rich stream 46, subsequent processes may remove water vapor from the stream 46. Between the second outlet 36 and the reactor inlet 38, elements may be added such as a heating element, compressor element, drying element, contaminant removing element, and combinations thereof.

An integral part of the system disclosed herein is the electrolyser 14. Those skilled in the art clearly recognize that there are various technologies and configurations possible to electrolyze water. There are three main water electrolysis technologies currently used at commercial scale and include 1.) alkaline water electrolysis (AEL), 2.) polymer electrolyte membrane (PEMEL), and 3.) solid oxide electrolyte (SOEL). In all these technologies, gas cross-over (e.g., H₂ going to the O₂ side and vice versa) is observed through the membrane that separates the cathode from the anode compartments. As a result, hydrogen gas formed at the cathode side leaks to the oxygen gas that is generated in the anode, thus requiring removal of the contaminating gas (e.g., H₂ or O₂) from the respective gas downstream of the electrolyser 14.

In the reactor 16, the gold-containing hydrogen removal catalyst 42 removes the H₂ in the O₂-rich stream 30. It has been surprising found that at O₂ partial pressures in the range of above approximately 1 bar, the gold-containing hydrogen removal catalyst 42 has improved activity and performance compared to noble metal hydrogen removal catalysts that do not contain gold. The reactor 16 may include one or more of a fixed bed reactor, a fluidized bed reactor, or both. In one embodiment, the catalyst beds 42 are stacked beds. In a preferred embodiment, the catalyst beds 42 have a packed catalyst bed configuration whereby the catalyst is fixed inside the reactor 16. The packed catalyst bed configuration may be non-cooled (e.g., an adiabatic reactor), cooled (e.g., promotes isothermal behavior), or both. Since the reaction between H₂ and O₂ is exothermic, a non-cooled catalyst bed configuration in which heat is not removed from the catalyst bed, results in an increase in temperature of the O₂-rich stream 30 in the reactor 16 as the reaction propagates through a length of the catalyst bed 40. Eventually, the O₂-rich stream 30 in the reactor 16 reaches a final adiabatic temperature rise. However, in a cooled catalyst bed configuration, heat is continuously removed throughout the length of the catalyst bed 40. As such, the temperature of the O₂-rich stream 30 may remain at or near a temperature of the reactor inlet 38 and does not reach an adiabatic temperature rise. In embodiments in which the catalyst bed 40 is a cooled catalyst bed configuration, the bed 40 may be a multitubular packed bed having the catalyst 42 packed in tubes surrounded by a heat exchange medium. The heat exchange medium may be water, steam, oil, molten salt, or any other suitable heat exchange medium and combinations thereof. The catalyst bed 42 of the present disclosure may be arranged in a variety of ways. For example, the catalyst bed 42 may have a single catalyst (e.g., the catalyst 42) filling the majority of an internal volume of the reactor 16. The catalyst 42 may be supported by a grating that holds the catalyst 42 within the reactor 16 while allowing the treated O₂-rich stream 46 to flow through the catalyst bed 40 and exit the reactor 16. In one preferred embodiment, between the grating and the catalyst bed 40, a support bed is made of inert material having grains of a larger size then the catalyst 42 (e.g., spherical support bed grains generally having a diameter of around 1 millimeter (mm) to 20 mm, depending on the catalyst grain size). Such a support bed helps to avoid the grating from being clogged by relatively small catalyst grains (e.g., grains having a diameter of around 0.5 mm to 4 mm). In another embodiment, the catalyst bed 40 is covered by a guard bed that is designed such that it will capture contaminants present in the O₂-rich stream 30 that may potentially harm (e.g., poison) the catalyst 42. As an example, oxygen streams coming from an alkaline electrolyser may carry small amounts of aqueous aerosols that contain high levels of potassium hydroxide (KOH). A guard bed having a high pore volume and/or an acidic nature may help to capture such aerosols while neutralizing and absorbing the alkaline KOH. Typical examples of such guard beds are activated alumina, silica and/or silica gel. Such guard bed also helps to buffer the relative humidity of the O₂-rich stream 30. In instances where the relative humidity becomes high and reaches concentrations close to 100%, such guard bed may temporarily absorb the water vapor during those extreme conditions.

In one alternative embodiment, two or more different catalyst materials with different composition are loaded in the bed, stacked upon each other. For example, the catalyst bed 40 may have a first bed having a first catalyst (e.g., the catalyst 42) filling its volume, and a second bed having a second catalyst (e.g., the catalyst 42) different from the first catalyst filling its volume. Such configuration may facilitate optimization of catalyst performance. The first catalyst may be positioned at an upstream portion of the catalyst bed 40 where the hydrogen concentration is still relatively high compared to a downstream portion of the catalyst bed 40. The first catalyst is designed to have a higher activity at low temperatures compared to the second catalyst. At a downstream section of the catalyst bed 40 the second catalyst is placed and is more robust towards higher temperatures and has a better performance at very low hydrogen concentrations compared to the first catalyst.

The catalyst 42 disclosed herein is preferably shaped into grains having enough size and intergrain porosity to generate a catalyst bed (e.g., the catalyst bed 40) with a low pressure drop. Preferred shapes for these catalysts are uniformly/regularly shaped grains. The catalyst grains may be pellets and/or extrudates. By way of non-limiting examples, the pellets and/or extrudates may be spherical, multilobe, rod-shaped, cylindrical, hollowed, multiholed, and combinations thereof. While irregularly shaped catalyst grains are less preferred, they may also be used in the catalyst bed 40. For fixed bed applications the diameter of the catalyst grains may be in the range of from approximately 0.5 mm to approximately 4 mm. Extrudates and pellets, where the length is appreciably higher than the diameter, the length may be in the range of from approximately 1 mm to approximately 10 mm. In fluidized bed applications, the catalyst grains may have a grain size distribution such that at least 60% of the catalyst particles have a particle diameter of below approximately 200 microns, and no more than approximately 40% of the catalyst particles have a diameter less than approximately 40 microns.

In an alternative to a catalyst bed filled with grains, the catalyst 42 may be shaped into a catalytically active structured body, whereby the structured body is optimized to minimize pressure drops and maximize accessibility to the catalyst 42. By way of non-limiting example, the structured body of the catalyst 42 may be honeycomb, monolith, corrugated foil, or foam. Such structures have a multitude of small repetitive elements such as the walls, foils and struts. Both these elements and the cavities between them have a dimension of approximately 0.2-4 mm. The catalytically active structured bodies of the catalyst 42 have dimensions that are much larger than the repetitive elements they contain, and may range from between approximately 5 mm to approximately 600 mm. The catalytically active material of the catalyst 42, being the combination of gold (Au), a second metal, and an oxidic support, may be part of the structure of this structured body or be present as a coating on the structured body. In the latter case, the coating may have a thickness of from between approximately 0.05 mm to approximately 1 mm.

As discussed above, the catalyst 42 contains Au mixed with another metal (i.e., second metal) on an oxidic support. The second metal may be selected from a Group VIIIB and/or a Group IB metal of the Periodic Table of Elements, whereby all metals having a hydrogen activation function are preferred. By way of non-limiting example, the second metal may be selected from nickel (Ni), cobalt (Co), copper (Cu), iridium (Ir), platinum (Pt), rhenium (Re), palladium (Pd), rhodium (Rh), and combinations thereof. Most preferred are noble metals that are regarded to be more prone to withstand the high oxygen partial pressures such as Pd, Pt, and Rh. In addition to the second metal, the catalyst may also contain a third metal or more additional metals.

The catalyst disclosed herein includes Au combined with another metal (i.e., a second metal) on an oxidic support, the Au is present in an amount of at least 0.01 wt % and the second metal is present in an amount of at least 0.005 wt % based on the total weight of the catalyst. As understood by a person skilled in the art, the activity and long-term performance of the catalyst is directly correlated to the metal loading. At the low metal loading of the catalyst disclosed herein (e.g., the catalyst 42), the activity and long-term performance tend to correlate linearly with the metal loading over a wide range. Catalysts having very low loadings generally require a very large reactor size to achieve maximum conversion. At very high metal loading (e.g., >5 wt. %), the linear correlation between activity and long-term performance with metal loading may weaken due to overcapacity, diffusion limitation and/or larger particle sizes of the precious metals. Optimizing the metal loading of the catalyst strongly depends on the desired process configuration and conditions.

The metal loading on the catalyst disclosed herein was determined using X-ray Fluorescence (XRF). However, as is appreciated by a person having ordinary skill in the art, other techniques may also be used to measure the amount of metal(s) on a catalyst. For example, catalyst metal loading may also be measured using Inductively Coupled Plasma Mass Spectrometry (ICP-MS) or Atomic Absorption Spectroscopy (AAS). These measurement techniques may also be used to determine the level of contaminants on the catalyst. For the XRF method Wave Dispersive X-ray Fluorescence (WDXRF) Spectrometry was applied. The sample was prepared by grinding using a disc mill (Herzog HSM 100P) for 1 min at 1420 rpm to a grain size of about d₅₀ 10 to 20 microns (μm) (d₉₀<80 μm). The sample was then mixed with a polyethylene wax binder (Ceridust 3620 by TER Chemicals) in a ratio of 80 wt % sample with 20 wt % binder and pressed into an alumina cup (40 mm diameter) via a Herzog HTP 40 press at 200 kN for 5 s to form a pill. This pill was then measured via WDXRF spectrometry (S8 Tiger 3 kW by Bruker AXS) using the standardless method Full Analysis Vac. The results were analyzed using Eval2 of the SpectraPlus software (V2.5.500 by Bruker AXS) and a matrix correction was applied. For this matrix correction the carrier material, in this case aluminum oxide (Al₂O₃), titanium oxide (TiO₂) or silicon oxide (SiO₂), is defined as the matrix of the sample to avoid overrepresentation of heavy elements towards the light element carrier material.

This XRF method was used to calculate both the metal loading and the contamination level in wt %, using the following definition:

$$Metal loading [ wt \% ] = weight of noble metal [ g ] / weight of total \\ \\ catalyst [ g ]$$

$$Contamination level [ wt \% ] = weight of contaminating element [ g ] / weight of total catalyst [ g ]$$

Based on this method, the total metal loading may also be calculated using the following definition:

$$Total metal loading [ wt \% ] = metal loading [ wt \% ] + second metal \\ \\ loading [ wt \% ] ,$$

whereby in case any additional group VIIIB or IB metal is present, the corresponding metal loading thereof will be added to the Total metal loading.
The mole ratio between gold and the second metal is calculated using the following definition:

$$Mole ratio Au / {2}^{nd} metal = ( Metal loading Au / Metal loading {2}^{nd} metal ) * ( MW second metal / 197 )$$

A particular aspect of the catalyst disclosed herein is the ratio between Au and the second metal. It was surprisingly found that a higher Au content relative to the second metal leads to a higher stability of the catalyst when used to remove hydrogen at high oxygen partial pressures. The disclosed catalyst has a mole ratio of Au to the second metal of at least approximately 0.1. Below this level the stabilizing effect of Au becomes limited resulting in a catalyst with suboptimal performance. However, the more Au that is loaded onto the catalyst, the more the second metal benefits from the stabilizing effect of the Au. The positive stabilizing effect the Au loading has on the second metal may begin to plateau at mole ratios above 10. In commercial practice, catalyst performance may be optimized by limiting the mole ratio of Au to the second metal to approximately 1 to 5 such that the benefit against the costs of the extra Au is optimized instead. A more cost efficient and significant effect could then be achieved by adding more of the second metal.

Another aspect of the catalyst disclosed herein is the support which is based on a material having an oxidic nature. This includes well known catalyst supports such as alumina, silica, silica-alumina, titania, zirconia, and mixtures thereof. Other less commonly used oxidic supports may be used such as, but not limited to, magnesia, calcium oxide, chromia, ceria, lanthanum oxide, manganese oxide, zinc oxide, tin oxide, and combinations thereof. The oxidic support may also include materials known to form an oxidic external surface when exposed to an oxygen atmosphere, such as metals, metal alloys, metal carbides, metal oxy carbides, metal nitrides, metal oxynitrides and metal sulfides. As an example, it is well known in the art that silicon carbide, upon exposure to oxygen, forms a silicon oxide layer of few nanometers thick and, as a result, will have surface properties that are similar if not identical to that of silica. The oxidic support may also include materials that are a mixture between a metal oxide and a non-metal oxide. Examples of such supports includes phosphates, borates, and sulfates. One example of such material is aluminum phosphate.

The oxidic support has a high specific surface area of more than approximately 10 square meters/gram (m²/g). For example, the oxidic support has a high specific area of more than approximately 20 m²/g, more preferably more than approximately 100 m²/g, and most preferably more than 200 m²/g. The water pore volume or specific pore volume of the support is in the range of from 0.30 cubic centimeters/gram (cc/g) to 1.00 cc/g. Preferably, the pore volume is in the range of from 0.50 cc/g to 0.80 cc/g. The porosity of the support structure is in the range of approximately 40 volume % (vol. %) to 90 vol. %, and preferably in the range of approximately 50 vol. % and 80 vol. %. The porosity is defined as the fraction of the volume of the pores in the support structure over the total volume of the support structure. The average pore size within the support structure is dependent on the support material, the specific surface area, and the porosity, and is generally between approximately 2 nanometers (nm) to 50 nm. The support structure may be such that it has a bimodal pore size distribution. Accordingly, pores in the range of from approximately 50 nm to 500 nm are also present. The surface area of the catalyst support disclosed herein was determined by gas physisorption applying the BET method, ASTM D 3663. Porosity, specific pore volume, and pore size distribution of the support were determined by mercury intrusion porosimetry, ASTM test method D 4284. The measurement of the pore size distribution of the support may be measured by any suitable measurement instrument using a contact angle of 140° with a mercury surface tension of 474 dyne/cm at 25° C.

The catalyst of the present disclosure may have a uniform distribution of the Au metal and the second metal across the catalyst grain or the repetitive element of the catalytically active structured body catalyst (e.g., pellet). In certain embodiments, the catalyst may also have a specific metal distribution, being either egg-shell, egg-yolk, or egg-white. With an egg-shell like distribution, the local metal concentration is the highest at or close to an external surface of the catalyst structure, the catalyst structure being a grain (e.g. sphere, extrudate or pellet), structured body (e.g. monolith or foam), or washcoat on such structured body. In an egg-yolk distribution, the metals are present in the middle of the catalyst structure, and, with an egg-white distribution, the metal concentration peaks somewhere between the middle and the external surface of the catalyst structure. Those skilled in the art will recognize the preparation parameters that result in this metal distribution such as by either the choice of the metal precursor, changing the pH of the metal precursor solution, buffering the pH of the metal precursor solution, and/or adding an adsorption modifier to the metal precursor solution that will improve or attenuate the adsorption propensity of the metal precursor to the support structure. Preferably the Au metal and the second metal have a similar distribution through the support structure. Although, in some cases, the distribution for each metal may be different. As a result, the local ratio between the Au and the second metal may vary within a catalyst structure.

As discussed above and in further detail below, the disclosed catalyst is used for low inlet temperature (e.g., preferably less than 160° C. more preferably less than 100° C.) selective hydrogen removal from O₂-rich streams having an O₂ partial pressure of greater than or equal to approximately 1 bar, such as those O₂-rich streams generated from the electrolysis of water. By using the catalyst of the present disclosure for H₂ removal from O₂-rich streams, the problems associated with using noble metal catalyst in oxidative environments at low temperature and high O₂ partial pressures may be mitigated and O₂ essentially free of H₂ may be obtained. As should be appreciated, the catalyst of the present disclosure is described in the context of a process for removing hydrogen from an O₂-rich stream generated in an electrolyser. However, the catalyst disclosed herein may be used in other processes that remove H₂ from O₂-rich streams (e.g., certain gas streams output by nuclear power plants) and system configurations that generate H₂-containing O₂-rich streams. In addition, process conditions may vary without departing from the scope of the present disclosure. For example, the catalyst disclosed herein may be used when process conditions include low entry temperatures (down to 60° C. or even ambient temperature), high catalyst bed temperatures (250° C., or even up to 350° C.), and high relative humidity of water vapor (up to 90%, or even 95%).

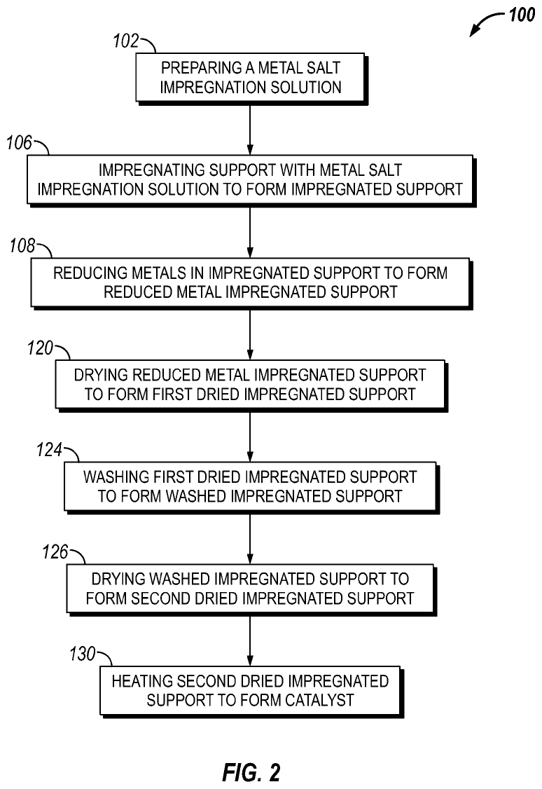

With the foregoing in mind, FIG. 2 is a flow diagram of a method 100 of making the bi-metallic catalyst of the present disclosure. The method 100 includes preparing a metal salt impregnation solution (block 102). The metal salt impregnation solution may be prepared by any suitable technique. For example, the metal salt may be dissolved in a desired volume of solvent (e.g., water). The metal salts used to prepare the impregnation solution(s) include, but are not limited to, noble metal salts from metals belonging to Groups VIIIB and IB of the Periodic Table of Elements, such as a palladium salt and a gold salt. By way of non-limiting example, the palladium precursor used in the preparation of the impregnation solution for making a catalyst based on palladium and gold is selected from i) the group of palladium salts consisting of palladium nitrate, palladium halide, chloropalladate salts, bromopalladate salts, palladium acetate, and palladium sulfate, or ii) the group of chelated palladium complexes consisting of ammoniacal complexes of palladium, (poly)amine complexes of palladium (such as ethylene diamine and diethylene triamine), (poly) carboxylic acid complexes of palladium (such as citric acid, gluconic acid), complexes combining carboxylic groups and amine groups (such as EDTA and NTA) of palladium, amino acid complexes of palladium, phosphine complexes of palladium and the gold salt used in the preparation of the impregnation solution is selected from the group of gold salts consisting of gold nitrate, gold halide, chloroauric acid, chloroaurate salts, sodium bromoauric acid, bromoaurate salts, dicyanoaurate salts, hydroxogold (III) complexes, gold acetate, and gold sulfate. The preferred palladium salt is palladium halide, tetrachloropalladate or palladium nitrate and the preferred gold salt is gold halide or a chloroaurate. In certain embodiments, the impregnation solution is a colloidal solution of nanometer sized particles containing a mixture of the palladium and gold, either as salt or as metal. In certain embodiments, when using an organic solvent, the precursor may be an organo-palladium and organo-gold compound. The solvent used to dissolve the noble metal precursors is water, an alcohol, a ketone, a hydrocarbon or other volatile solvent, and combinations thereof. In a preferred embodiment, the solvent is water. Other components may be added to the solvent to adjust the pH, facilitate the imbibition of the porous support, adjust the viscosity of the solvent, and/or control the interaction between the precursor and the support. The amount of solvent used to dissolve the noble metal salts is preferably such that it is equal to the pore volume of the support. The relative amounts of the palladium salt and gold salt in the impregnation solution(s) are such that the catalyst of the present disclosure has approximately 0.005 wt % and 0.5 wt % palladium and approximately 0.01 wt % to 2 wt % gold. Catalysts having other metals may use similar precursors and made via a similar approach.

Following preparation of the impregnation solution(s) according to the acts of block 102, the method 100 includes impregnating a support/carrier with the impregnation solution to form an impregnated support (block 106). For example, the impregnation solution may be sprayed onto the support at ambient temperature in a manner that the pores of the support are filled by the impregnation solution. However, any other suitable impregnation technique may be used to fully impregnate the pore structure of the support such as, for example, incipient wetness impregnation, immersion impregnation and wet impregnation. In one embodiment, only a portion of the support pore volume becomes impregnated by the impregnation solution. In this particular embodiment, in order to achieve a uniform distribution over the support, the solution is sprayed with a fine spray while tumbling the support in a rotating drum.

Following impregnation of the support in accordance with block 106, the noble metals in the impregnated support are reduced to form a reduced metal impregnated support (block 108). For example, the reduction is accomplished by treating the impregnated support with a solution having a reduction agent. The reduction agent may be any suitable reduction agent such as, for example, hydrazine (N₂H₄), formic acid, formiate salts, formaldehyde, acetaldehyde, and sodium borohydride. The added volume of the reduction agent solution is at least 80% compared to the pore volume. If the added volume is significantly larger than the pore volume, the surplus of the reduction agent solution is decanted after the reduction has been completed.

In a particular embodiment the reduction agent can already be added to the impregnation solution whereby the reduction is completed by an increase of the temperature after impregnating this combined solution.

The method 100 also includes drying the reduced metal impregnated support to form a first dried impregnated support (block 120). For example, the impregnated support is dried in a stream of air with the temperature of the air being between approximately 80° C. and approximately 175° C. for 5 to 30 minutes. After the drying step according to the acts of block 120, the remaining solvent on the support is less than approximately 5 wt % compared to the weight of the support.

In certain embodiments, the reduced metal impregnated support may be equilibrated prior to decanting and drying to ensure that the porous support/carrier absorbs the remaining amount of impregnation solution and/or the added reducing agent solution, and to allow the reduction of the impregnated metal(s) to proceed to a maximum degree of reduction. That is, the carrier/support and impregnation solution are tumbled together for a time sufficient to allow equilibration to occur such that the support is no longer able to take up (absorb) the impregnation solution and/or the reducing agent solution, and to allow enough time to reach proper reduction of the metal precursor to produce the reduced metal. To achieve a faster completion of the degree of reduction the temperature of the reduced metal impregnated support may be raised.

In an optional step, following drying in accordance with block 120, the first dried impregnated support may undergo a washing step to form a washed impregnated support (block 124). For example, the first dried impregnated support is washed with a volume of washing fluid (e.g., deionized water or a solution containing non-halogen ions) to remove contaminants such as, but not limited to, sodium, potassium, chlorides, bromides, or any other element that may undesirably impact the performance of the catalyst. To facilitate washing of internal pores of the porous support, the volume of water of the first washing step should be more than the pore volume of the first dried impregnated support. The volume of washing fluid added during the subsequent washing steps may be approximately equal to the volume of the support. After the first or subsequent addition of washing fluid, the impregnated support is left together with the washing fluid for a few minutes to allow diffusion of contaminants out of the porous support. After each washing step the excess washing fluid may be removed by decantation. This washing is repeated until the washed impregnated support is essentially free of contaminants. The level of contaminants on the catalyst was assessed using X-ray fluorescence (XRF). However, Inductively Coupled Plasma Mass Spectrometry (ICP-MS) or Atomic Absorption Spectroscopy (AAS) may also be used to determine the level of contaminants on the catalyst.

The method 100 also includes drying the washed impregnated support to form a second dried impregnated support (block 126) and, optionally, heating the second dried impregnated support to form the catalyst (block 130). For example, the washed impregnated support is dried in air at a temperature of between approximately 100° C. and approximately 175° C. for 4 to 8 hours. After drying the washed impregnated support, the remaining solvent on the second dried impregnated support is less than approximately 5 wt % compared to the weight of the support. Following the drying step of block 126, the second dried impregnated support may be optionally subjected to one heat treatment or a series of heat treatments. During such heat treatment, the catalyst is heated at a temperature of in the range of approximately 250° C. and 600° C. for between 10 minutes and 2 hours. The heat treatment may be carried out in air or inert gas or both. This heat treatment serves the purpose of removing non-ash producing species from the catalyst, such as remaining nitrates, carbonates, or other carbon or nitrogen containing molecules.

In embodiments where the dried impregnated support is heat treated according to the acts of block 130, preferably at least one heat treatment is carried out in a reducing, preferably hydrogen containing atmosphere. Preferably the at least one heat treatment (e.g., a reducing heat treatment) is carried out after the oxidative or inert heat treatment or, in certain embodiments, is carried out as a replacement of the oxidative or inert heat treatment. If other components in the hydrogen-containing gas used in the at least one heat treatment have an inert character (such as would be with argon, nitrogen and helium present in the hydrogen-containing gas) the concentration of the hydrogen may be lower (e.g., below 95% compared to a hydrogen-containing gas that does not have components with an inert character) and still achieve the desired reduction effect. To allow proper kinetics, preferably the hydrogen concentration in the hydrogen-containing gas is in excess of 1 volume %. During this at least one heat treatment, the catalyst is heated at a temperature of in the range of approximately 250° C. and 400° C. for between 10 minutes and 2 hours.

The reducing heat treatment can be carried out in separated equipment as the oxidative treatment, although using a separate equipment for the oxidative heat treatment and the reductive heat treatment is preferred. In one preferred embodiment, the reducing heat treatment is carried out in the same reactor equipment as where the actual catalytic removal reaction will take place. Such reductive heat treatment can also be carried out to regenerate or rejuvenate a spent catalyst. This may either be carried out outside the reactor equipment where the actual catalytic removal reaction will take place, or inside the reactor equipment.

As should be appreciated, the manner in which a catalyst is prepared impacts its characteristics, such as for instance the particle size of the metal particles within the support. Such particle size may impact the performance of the catalyst. The size of the metal particles present within an internal pore volume of the oxidic support of the disclosed catalyst may be in the nanometer range. This is highly desirable as the Au and the second metal are highly expensive. Therefore, it is important to maximize the catalytic performance per unit of precious metal mass. This is achieved through nanometer sized metal alloy particles (i.e., Au and second metal alloy particles). However, when the particle size of the majority of the metal alloy particles become very small (e.g., below 4 nm), the chemical nature of the surface of these metal alloys can change dramatically and may lead to a completely different catalytic behavior. Consequently, the catalytic performance per unit of precious metal mass may dramatically decrease when going to very small particles. As appreciated by a person of skill in the art, this requires optimization to maximize catalytic activity.

The particle size of the metal nanoparticles may be measured using any suitable technique known in the art. By way of non-limiting example, the particle size of the metal nanoparticles may be measured using transmission electron microscopy, x-ray photoelectron microscopy (XPS), and chemisorption, among others. As should be appreciated by a person of ordinary skill in the art, the particle size of the metal particles may vary according to the measurement technique. For example, when using CO chemisorption, the metal particle size of the catalyst disclosed herein revealed a mean particles size of 16 nm. However, for example, when using transmission electron microscopy, the particle size of metal particles of the catalyst disclosed herein revealed most metal particles having a diameter of less than 50 nm, of which most particles having a diameter between 2 nm and 27 nm, with a mean particle size of 6.5 nm.

As may be appreciated by a person having skill in the art, the surface composition of metal particles on the catalyst determines its catalytic properties. Such surface composition may be appreciably different from the bulk composition of the metal particle and, as a result, the activity is not necessarily governed by the bulk composition of the metal particles. The metal distribution within each metal particle and, in particular, its surface composition may strongly depend on the conditions during the preparation of the catalyst and/or pretreatment of the catalyst. Moreover, the metal distribution and/or the surface composition of the catalyst may change during use in system processes. The catalyst activity may be improved or attenuated by varying system operating conditions such that the surface composition becomes changed.

### Catalyst Compostions Tested for Catalyst Activity

### Example 1—Inventive

This Example 1 describes the preparation of Catalyst 1 that is representative of the inventive catalyst.

An impregnating solution is made by dissolving an amount of sodium tetrachloropalladate (Na₂PdCl₄) and chloroauric acid (HAuCl₄) in a volume of water that is equal to the water pore volume of the alumina support such that the concentration of that solution yields approximately 0.1 wt % Pd and 0.05 wt % Au on the final catalyst. At ambient temperature, the impregnating solution is sprayed onto the alumina support. The alumina support is a spherical 2.5 mm diameter alumina support having a BET surface area of around 210 m²/g and having a pore volume of approximately 0.78 milliliters/gram (ml/g). The impregnated alumina support is treated with a volume of 2.3 wt % hydrazine (N₂H₄) solution to reduce the Pd and Au in the impregnated alumina support. The volume of the hydrazine solution is approximately equal to the pore volume of the alumina support. Following reduction, the resultant support and hydrazine solution are tumbled together for 10 minutes to allow equilibration and ensure that the support absorbed the maximum amount of hydrazine and to complete the reduction reaction before the resultant support is dried at 150° C. in air for 45 minutes, thereby forming a first dried impregnated support. The first dried impregnated support is washed in a stepwise manner with a volume of distilled or deionized water until the resultant wash water is essentially free of chlorides. The volume of distilled or deionized water is approximately equal to a volume of the first dried impregnated support. Excess wash water is decanted before the washed impregnated support is dried at 120° C. for approximately 6 hours to form a second dried impregnated support. The second dried impregnated support using contained 0.102 wt % Pd and 0.050 wt % Au and 0.009 wt % chloride as measured by XRF. The second dried impregnated support is heated at 300° C. for approximately 1 hour in a hydrogen atmosphere to form the inventive catalyst.

### Example 2—Comparative

This Example 2 describes the preparation of Catalyst 2 that is representative of the comparative catalyst.

An impregnating solution is made by dissolving an amount of palladium nitrate (Pd(NO₃)₂) in a volume of water that is equal to the water pore volume of the alumina support that yields approximately 0.1 wt % Pd on the final catalyst. At ambient temperature, the impregnating solution is sprayed onto the alumina support. The alumina support is a spherical 2.5 mm diameter alumina support having a BET surface area of around 210 m²/g and having a pore volume of approximately 0.78 milliliters/gram (ml/g), which corresponds with a porosity of 75%. Following impregnation, the impregnated alumina support is conditioned for 5 minutes, pre-dried at 150° C. for 20 minutes followed by drying at 120° C. for 6 hours, thereby forming a dried catalyst. The dried catalyst is calcined at 450° C. for 3 hours before being treated with a volume of 2.3 wt % hydrazine (N₂H₄) solution to reduce the Pd in the impregnated alumina support. The volume of the hydrazine solution is approximately equal to the pore volume of the alumina support. Following reduction, the resultant support is pre-dried at 150° C. for 45 minutes followed by drying at 120° C. for 6 hours, thereby forming a dried impregnated support. The dried impregnated support is heated at 300° C. for approximately 1 hour in a hydrogen atmosphere to form the inventive catalyst.

### Example 3—Comparative

This Example 3 describes the preparation of Catalyst 3 that is representative of the comparative catalyst.

An impregnating solution is made by dissolving an amount of palladium nitrate (Pd(NO₃)₂) in a volume of water that is equal to the water pore volume of the alumina support that yields approximately 0.5 wt % Pd on the final catalyst. At ambient temperature, the impregnating solution is sprayed onto the alumina support. The alumina support is a spherical 2.5 mm diameter alumina support having a BET surface area of around 210 m²/g and having a pore volume of approximately 0.78 milliliters/gram (ml/g), which corresponds with a porosity of 75%. Following impregnation, the impregnated alumina support is conditioned for 5 minutes, pre-dried at 150° C. for 20 minutes followed by drying at 120° C. for 6 hours, thereby forming a dried catalyst. The dried catalyst is calcined at 450° C. for 3 hours before being treated with a volume of 2.3 wt % hydrazine (N₂H₄) solution to reduce the Pd in the impregnated alumina support. The volume of the hydrazine solution is approximately equal to the pore volume of the alumina support. Following reduction, the resultant support is pre-dried at 150° C. for 45 minutes followed by drying at 120° C. for 6 hours, thereby forming a dried impregnated support. The dried impregnated support is heated at 300° C. for approximately 1 hour in a hydrogen atmosphere to form the inventive catalyst.

### Example 4—Comparative

This Example 4 describes the preparation of Catalyst 4 that is representative of the comparative catalyst.

An impregnating solution is made by dissolving an amount of palladium nitrate (Pd(NO₃)₂) and platinum nitrate (Pt(NO₃)₂) in a volume of water that is equal to the water pore volume of the alumina support that yields approximately 0.1 wt % Pd and approximately 0.05 wt % Pt on the final catalyst. At ambient temperature, the impregnating solution is sprayed onto the alumina support. The alumina support is a spherical 2.5 mm diameter alumina support having a BET surface area of around 210 m²/g and having a pore volume of approximately 0.78 milliliters/gram (ml/g), which corresponds with a porosity of 75%. Following impregnation, the impregnated alumina support is conditioned for 5 minutes, pre-dried at 150° C. for 20 minutes followed by drying at 120° C. for 6 hours, thereby forming a dried catalyst. The dried catalyst is calcined at 450° C. for 3 hours before being treated with a volume of 2.3 wt % hydrazine (N₂H₄) solution to reduce the Pd and Pt in the impregnated alumina support. The volume of the hydrazine solution is approximately equal to the pore volume of the alumina support. Following reduction, the resultant support is pre-dried at 150° C. for 45 minutes followed by drying at 120° C. for 6 hours, thereby forming a dried impregnated support. The dried impregnated support is heated at 300° C. for approximately 1 hour in a hydrogen atmosphere to form the inventive catalyst.

### Example 5—Comparative

This Example 5 describes the preparation of Catalyst 5 that is representative of the comparative catalyst.

An impregnating solution is made by dissolving an amount of palladium nitrate (Pd(NO₃)₂) and silver nitrate (AgNO₃) in a volume of water that is equal to the water pore volume of the alumina support that yields approximately 0.1 wt % Pd and approximately 0.05 wt % Ag on the final catalyst. At ambient temperature, the impregnating solution is sprayed onto the alumina support. The alumina support is a spherical 2.5 mm diameter alumina support having a BET surface area of around 210 m²/g and having a pore volume of approximately 0.78 milliliters/gram (ml/g), which corresponds with a porosity of 75%. Following impregnation, the impregnated alumina support is conditioned for 5 minutes, pre-dried at 150° C. for 20 minutes followed by drying at 120° C. for 6 hours, thereby forming a dried catalyst. The dried catalyst is calcined at 450° C. for 3 hours before being treated with a volume of 2.3 wt % hydrazine (N₂H₄) solution to reduce the Pd and Ag in the impregnated alumina support. The volume of the hydrazine solution is approximately equal to the pore volume of the alumina support. Following reduction, the resultant support is pre-dried at 150° C. for 45 minutes followed by drying at 120° C. for 6 hours, thereby forming a dried impregnated support. The dried impregnated support is heated at 300° C. for approximately 1 hour in a hydrogen atmosphere to form the inventive catalyst.

### Example 6—Comparative

This Example 6 describes the preparation of Catalyst 7 that is representative of the comparative catalyst containing only Pt.

An impregnating solution is made by dissolving an amount of platinum nitrate (Pt(NO₃)₂) in a volume of water that is equal to the water pore volume of the alumina support that yields approximately 0.3 wt % Pt on the final catalyst. At ambient temperature, the impregnating solution is sprayed onto the alumina support. The alumina support is a spherical 2.5 mm diameter alumina support having a BET surface area of around 210 m²/g and having a pore volume of approximately 0.78 milliliters/gram (ml/g), which corresponds with a porosity of 75%. Following impregnation, the impregnated alumina support is conditioned for 5 minutes, pre-dried at 150° C. for 20 minutes followed by drying at 120° C. for 6 hours, thereby forming a dried catalyst. The dried catalyst is calcined at 450° C. for 3 hours before being treated with a volume of 2.3 wt % hydrazine (N₂H₄) solution to reduce the Pt in the impregnated alumina support. The volume of the hydrazine solution is approximately equal to the pore volume of the alumina support. Following reduction, the resultant support is pre-dried at 150° C. for 45 minutes followed by drying at 120° C. for 6 hours, thereby forming a dried impregnated support. The dried impregnated support is heated at 300° C. for approximately 1 hour in a hydrogen atmosphere to form the inventive catalyst.

### Example 7—Comparative

This Example 7 describes the preparation of Catalyst 7 that is representative of the comparative catalyst containing only Au.

An impregnating solution is made by dissolving an amount of chloroauric acid (HAuCl₄) in a volume of water that is equal to the water pore volume of the alumina support such that the concentration of that solution yields approximately 0.1 wt % Au on the final catalyst. At ambient temperature, the impregnating solution is sprayed onto the alumina support. The alumina support is a spherical 2.5 mm diameter alumina support having a BET surface area of around 210 m²/g and having a pore volume of approximately 0.78 milliliters/gram (ml/g). The impregnated alumina support is treated with a volume of 54 wt % sodium formate solution to reduce the Au in the impregnated alumina support. The volume of the sodium formate solution is approximately equal to the pore volume of the alumina support. Following reduction, the resultant support and sodium formate solution are tumbled together for 10 minutes to allow equilibration and ensure that the support absorbed the maximum amount of sodium formate and to complete the reduction reaction before the resultant support is dried at 150° C. in air for 45 minutes, thereby forming a first dried impregnated support. The first dried impregnated support is washed in a stepwise manner with a volume of distilled or deionized water until the resultant wash water is essentially free of chlorides. The volume of distilled or deionized water is approximately equal to a volume of the first dried impregnated support. Excess wash water is decanted before the washed impregnated support is dried at 120° C. for approximately 6 hours to form a second dried impregnated support. The second dried impregnated support is heated at 300° C. for approximately 1 hour in a hydrogen atmosphere to form the inventive catalyst.

Table 2 below provides properties of the selective hydrogenation Catalysts 1-7 of Examples 1-7 above.

TABLE 2
Properties of Inventive and Comparative Hydrogen removal Catalysts

| | CAT 1 | CAT 2 | CAT 3 | CAT 4 | CAT 5 | CAT 6 | CAT 7 |
|---|---|---|---|---|---|---|---|
| BET Surface | 210 | 210 | 210 | 210 | 210 | 210 | 210 |
| Area (m²/g) | | | | | | | |
| Pd (wt %) | 0.1 | 0.1 | 0.5 | 0.1 | 0.1 | 0 | 0 |
| Pt (wt %) | 0 | 0 | 0 | 0.05 | 0 | 0.3 | 0 |
| Ag (wt %) | 0 | 0 | 0 | 0 | 0.05 | 0 | 0 |
| Au (wt %) | 0.05 | 0 | 0 | 0 | 0 | 0 | 0.05 |

### Example 8—Performance Testing

Example 8 describes the performance testing done to characterize the hydrogen removal activity of the catalyst compositions of Examples 1-7.

Experimental conditions were chosen which closely resemble those used for hydrogen removal of O₂-rich streams using a feed gas composition typical of an electrolyser O₂ off gas. For example, a laboratory reactor was filled with 15 ml of catalyst. An O₂-rich feed having 1000 ppm of H₂, and 3.5 vol % water vapor (equivalent to 0.17 bar patial pressur and dew point of 57° C.) was fed to the reactor at a rate providing a GHSV of 2500 v/vh. The reactor was operated at an O₂ partial pressure of 5 bar and at three different temperatures of 80° C., 120° C., and 160° C.

Table 3 illustrates the performance the Catalysts 1-7 of Examples 1-7 as a function of temperature. As is clear from Table 3, the H₂ concentration in the O₂-rich gas stream at temperatures in the range of from between 80° C. and 160° C. when using the inventive catalyst (Example 1) is reduced from 1000 ppmv to less than approximately 10 ppmv. In contrast, O₂-rich gas streams treated with catalysts that do not contain Au (e.g., Examples 3-6) as well as the catalyst that only had Au (e.g. Example 7) had H₂ concentrations of 400 ppmv or more at 80° C. Even at 120° C., the O₂-rich gas streams treated with certain comparative catalysts (e.g., Examples 2, 4, 5 and 7) had H₂ concentrations above 150 ppmv. Only after the reaction temperature was raised to 160° C. did catalysts having either Pd/Pt or high Pd loading reduce the H₂ concentration in the O₂-rich gas stream to a level comparable to that of the inventive Pd/Au catalyst. Therefore, the inventive Catalyst 1 removed the H₂ from the O₂-rich gas stream at temperatures less than 120° C. such that the resultant O₂-rich gas stream had a H₂ concentration less than approximately 10 ppmv. From these examples it is clear that when Au is added to Pd it leads to a substantially improved performance. The very low conversion over the whole temperature range for EX 7 on the other hand, illustrates that it is not Au itself that creates the activity. Without being bound by theory, it is believed that the additon of Au to the catalyst creates a more oxidation resistant catalytic system.

Table 3. below shows the outlet hydrogen concentration (ppmv) at three different temperatures for each catalyst sample.

TABLE 3
Outlet Hydrogen Concentration of O₂-rich gas stream

| TEMP (° C.) | EX 1 | EX 2 | EX 3 | EX 4 | EX 5 | EX 6 | EX 7 |
|---|---|---|---|---|---|---|---|
| 80 | 8 | 836 | 400 | 800 | 950 | 690 | 1010 |
| 120 | 0 | 790 | 27 | 170 | 430 | 60 | 950 |
| 160 | 0 | 560 | 18 | 6 | 22 | 2 | 870 |

### Catalyst Compositions Tested for Catalyst Stability

### Examples 9-20—Inventive

These Examples describe the preparation of Catalysts 9-20 that are representative of the inventive catalysts.

Catalysts 9-20 were prepared in the same manner. Metal precursors salts, their respective concentrations, and the support were varied and summarized in Table 4.

An impregnating solution is made by dissolving an amount of chloroauric acid (HAuCl₄) as the Au precursor and second metal precursor in a volume of water that is equal to the water pore volume of the oxidic support such that the concentration of that solution after evaporation yields the desired concentration of metals on the final catalyst. At ambient temperature, the precursor solution is sprayed onto the oxidic support. The impregnated oxidic support is dried at 65° C. in air for 15 minutes, thereby forming a first dried impregnated support. The dried impregnated support is treated with a volume of 20 g/l ascorbic acid solution to reduce the metals in the impregnated support. The volume of the added ascorbic acid solution is approximately equal to the pore volume of the oxidic support. Following this reduction step, the resultant support and ascorbic acid solution are tumbled together for 10 minutes to allow equilibration and ensure that the support absorbed the maximum amount of ascorbic acid and to complete the reduction reaction. The reduced resultant support is washed six times with a volume of deionized water. Deionized water is added with a volume three times the volume of the first dried impregnated support and thereafter the support and washing liquid are tumbled together for 10 minutes for each washing. After each washing, the liquid is decanted. Following the washing step, the washed impregnated support is dried at 120° C. for approximately 6 hours to form a second dried impregnated support.

As discussed above, the metal precursors and oxidic support for Catalyst 9-20 are summarized in Table 4 below. The alumina support is a spherical 1.8 mm diameter alumina support having a BET surface area of around 210 m²/g and having a pore volume of approximately 0.65 milliliters/gram (ml/g). The titania support is a 1.6 mm diameter trilobal extrudate, containing anatase as the titania phase, having a BET surface area of around 45 m²/g and having a pore volume of approximately 0.32 ml/g. The silica support is a 1.6 mm diameter spherically shaped silica, having a BET surface area of around 300 m²/g and having a pore volume of approximately 0.85 ml/g.

### Examples 21-23—Comparative

These Examples describes the preparation of Catalysts 21-23 that are representative of the comparative catalysts.

Catalysts 21-23 were made in a manner similar to catalysts 9-20. Catalysts 21-23 contained a single metal and their composition, respective metal precursor, and oxidic support are summarized in Table 3.

### Example 24—Performance Testing

Example 24 describes the performance testing done to characterize the stability of the catalyst compositions of Catalysts 9-23.

Experimental conditions chosen closely resemble those used for hydrogen removal of O₂-rich streams using a feed gas composition typical of an electrolyser O₂ off gas. To determine the stability of the catalyst, each catalyst sample tested was subjected to a temperature that is typical in an adiabatic reactor where the temperature increases substantially because of the exotherm of the reactor, for these tests 230° C. A laboratory reactor was filled with 1 ml of a respective catalyst sample. The catalyst sample was exposed to a 4 bar absolute pressure pure oxygen stream for 48 hours at 230° C. Before and after this treatment the activity of the catalyst sample was evaluated with an oxygen rich feed having 5000 ppm of H₂, and a flow rate rate providing a GHSV of 25000 v/vh. The reactor was operated at an O₂ partial pressure of 1.4 bar and at a temperature of 50° C. Based on the hydrogen conversion in the reactor a first order activity constant was determined according to the following formula:

$${k}_{A} [ {s}^{- 1} ] = {H}_{2} flow [ mol / s / {m}^{3} ] * LN ( 1 / ( 1 - {H}_{2} Conversion ) ) / {H}_{2} concentration [ mol / {m}^{3} ]$$

wereby k_{A}[s⁻¹] is the first order activity constant of the catalyst and the term LN is the natural logarithm, and whereby the H₂ conversion is defined by the following formula:

$$Stability ratio = {k}_{A} ( after high temperature treatment ) / {k}_{A} ( before high temperature treatment )$$

By comparing the activity constant before and after the high temperature treatment an indication of the stability can be achieved. The stability ratio is defined as

$${H}_{2} conversion = ( {H}_{2} inlet concentration [ mol / {m}^{3} ] - {H}_{2} outlet concentration [ mol / {m}^{3} ] ) / {H}_{2} inlet concentration [ mol / {m}^{3} ] ) .$$

A stability ratio below unity indicates deactivation, a stability ratio around or even above unity indicates a high stability or even self-activation.

Table 4 below illustrates the compositions of the various catalysts of Catalysts 9-23 as well as their first order activity constant k_{A} after long exposure to 4 bara of oxygen at 230° C. and the stability ratio.

TABLE 4
Properties of Inventive and Comparative Catalysts 9-23

| | | 2nd metal | Gold | Mole | | |
|---|---|---|---|---|---|---|
| Example | 2nd metal | content | content | Ratio | Activity | Stability |
| # | precursor | (wt %) | (wt %) | Au:2^{nd} metal | constant | Ratio |
| 9 | Pd(NO₃)₂ | 0.1 | 0.05 | 0.27 | 8.8 | 1 |
| 10 | Pd(NO₃)₂ | 0.1 | 0.2 | 1.08 | 20.3 | 1.7 |
| 11 | Na₂PdCl₄ | 0.1 | 0.05 | 0.27 | 15 | 0.7 |
| 12 | Na₂PdCl₄ | 0.1 | 0.2 | 1.08 | 15.6 | 1.1 |
| 13 | Na₂PdCl₄ | 0.1 | 0.5 | 2.69 | 36.7 | 1.8 |
| 14 | Na₂PdCl₄ | 0.1 | 1 | 5.38 | 42.8 | 6 |
| 15 | Na₂PdCl₄ | 0.1 | 2 | 10.76 | 51.4 | 6.2 |
| 16 | Pt(NO₃)₂ | 0.1 | 0.05 | 0.49 | 7.2 | 0.6 |
| 17 | Pt(NO₃)₂ | 0.1 | 0.2 | 1.98 | 23.9 | 0.7 |
| 18* | Na₂PdCl₄ | 0.1 | 0.05 | 0.27 | 8.7 | 1.2 |
| 19** | Na₂PdCl₄ | 0.1 | 0.05 | 0.27 | 11 | 0.4 |
| 20 | Na₂PdCl₄ | 0.01 | 0.02 | 1.08 | 1.4 | 1.1 |
| 21 | Pd(NO₃)₂ | 0.1 | — | — | 1.8 | 0.3 |
| 22 | Pt(NO₃)₂ | 0.1 | — | — | 0.3 | 0.9 |
| 23 | — | — | 0.2 | — | 0.1 | 1.1 |

*TiO₂ supported,
**SiO₂ supported

As shown in Table 4, the activity and the stability ratio of the inventive Catalysts 9-15 is better compared to Catalyst 21 indicating that Pd-containing catalysts (e.g., the Catalysts 9-15) benefit from the addition of Au. Pd-containing catalyst without Au (e.g, Catalysts 21 and 22) have a low stability ratio and a low activity after high temperature treatment compared to the inventive Pd—Au Catalysts 9-15. When comparing the activity and the stability ratio of the inventive Pt—Au Catalysts 16 and 17 with the activity and stability ratio of Catalyst 22, it becomes clear that also a Pt-containing catalysts benefit from the addition of Au. Pt-containing catalyst without Au (e.g., Catalyst 22) have a low stability ratio and a low activity after high temperature treatment compared to the inventive Pt—Au-Catalysts 16 and 17. Similar to the single metal catalysts, which have only Pd or Pt as the active metal, catalysts having Au as the single active metal alos have a low stablity ration and low activty after high temperature treatment. For example, as shown in Table 4, the activity and the stability ratio of the inventive Catalysts 10 and 17 is higher compared to that of Catalyst 23, which contains the same Au loading as the inventive Catalysts 10 and 17. It is clear that Pd, Pt, and Au alone are not sufficient to achieve the activity and stability ratio observed in the inventive Catalysts 9-20 for applications that remove H₂ from O₂-rich streams. Rather, the improved activity and stability ratio are a result of the combination of Au with another noble metal (i.e., the second metal).

Moreover, as shown in Table 4, the catalyst stability of inventive Catalysts 9-15 improves as the Au content and mole ratio of Au over the second metal increases. Similarly, comparing inventive Catalysts 16 and 17, as the Au content and mole ratio of Au over the second metal increase, improved stability is observed.

Additionally, comparing the stability of inventive Catalysts 13 and 20, it is apparent that, at low Au and second metal loadings, the stability ratio is above 1, indicating a high stability of these catalysts. Furthermore, Catalyst 20 has a higher stability at a lower metal loading of 0.03 wt % compared to comparative Catalysts 21 and 22, which have a total metal loading of 0.1 wt % Pd and 0.1 wt % Pt, respectively. As should be noted, the choice of Pd precursor used when preparing the catalysts is not critical. For example, inventive Catalyst 10 and 12 have comparable activity and stability, as shown in Table 4.

The impact on catalyst activity and stability of different oxidic supports was also evaluated. As shown in Table 4, inventive Catalysts 9 and 11, which use alumina as the oxidic support have similar activity compared to inventive Catalysts 18 and 19, which use titania and silica, respectively, as the oxidic support. At the same metal loading for each Catalyst 9, 11, 18, and 19, all these catalysts showed a similar activity within the range of 8-15 s⁻¹ after the deactivation test at 230° C. despite the fact that they have different oxidic carriers having surface areas ranging from 45 to 300 m²/g and shapes. Without wishing to be bound by theory, the effect of stabilisation appears to be governed by the presence of Au in the catalyst and, to a lesser degree, by the nature and properties of the oxidic support.

The technical effects of using the catalyst disclosed herein for H₂ removal from O₂-rich gas streams, such as those generated in an electrolyser, provide for effective and efficient removal of H₂ at temperatures below 160° C., in particular below 100° C. in oxidizing conditions with high partial pressures of oxygen. The addition of Au to these catalysts mitigates the oxidation of the catalyst and improves the H₂ removal performance of the catalyst at O₂ partial pressures above 1 bar, in particular at 5 bar or higher. Therefore, it is the combination of the addition of Au, with a second metal that results in the desirable H₂ removal activity at low temperatures (e.g., less than 160° C.) under oxidative conditions (e.g., O₂ partial pressure above 1 bar).

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

1. A process for removing hydrogen from an oxygen gas stream, comprising:
electrolyzing water in an electrolyser to generate a hydrogen rich stream and an oxygen rich stream, wherein the oxygen rich stream comprises hydrogen;
feeding the oxygen rich stream to a reactor comprising a gold-containing catalyst; and
contacting, in the reactor, the oxygen rich stream with the gold-containing catalyst, wherein the gold-containing catalyst comprises gold and a second metal on an oxidic support, wherein an oxygen partial pressure of the oxygen-rich stream in the reactor is greater than 1 bar.

2. The process of claim 1, wherein a temperature at an inlet of the reactor is between 40 degrees Celsius (° C.) and 160° C.

3. The process of claim 1, wherein greater than 95% of the hydrogen is removed from the oxygen gas stream.

4. The process of claim 1, wherein the second metal is selected from Group VIIIB and/or Group IB metal of the Periodic Table of Elements.

5. The process of claim 4, wherein the second metal is palladium, platinum, or rhodium.

6. The process of claim 5, wherein the second metal is present in an amount of at least 0.005 wt %, and wherein the gold is present in amount of at least 0.01 wt %.

7. The process of claim 6, wherein the amount of the second metal is measured by X-Ray Fluorescence (XRF).

8. The process of claim 1, wherein a mole ratio of the gold to the second metal is at least 0.1.

9. The process of claim 1, wherein the gold-containing catalyst has a porosity of between 40 volume % (vol. %) and 90 vol. %, preferably between 50 vol. % and 80 vol. %.

10. The process of claim 9, wherein the porosity is measured by mercury intrusion porosity according to ASTM test method D 4284.

11. The process of claim 1, wherein the oxidic support has a specific surface area of more than 10 square meters/gram (m²/g).

12. The process of claim 11, wherein the specific surface area is greater than 200 m²/g.

13. The process of claim 11, wherein the specific surface area is measured by gas physisorption according to BET method, ASTM D 3663.

14. The process of claim 1, wherein the gold is present in an amount of at least 0.01 weight percent (wt. %).

15. The process of claim 14, wherein the amount of gold is measured by XRF.

16. The process of claim 1, wherein the oxidic support is alumina, silica, silica-alumina, titania, zirconia, and combinations thereof.

17. The process of claim 1, wherein a total metal content of the gold-containing catalyst is between 0.03 wt % and 2.1 wt %.

18. The process of claim 17, wherein the total metal content is measured by XRF

19. The process of claim 1, wherein at least the gold or the second metal in the catalyst has a mean particle size greater than 4 nanometers (nm) nanometers (nm).

20. The process of claim 19, wherein the mean particle size is measured by CO chemisorption.

21. The process of claim 19, wherein the mean particle size is measured by TEM.
